(19) United States
(12) Patent Application Publication
(10) Pub. No.: US 2012/0092160 A1
(43) Pub. Date: Apr. 19, 2012

(54) Dual-Signaling Location System

(76) Inventors: Rickey Antonucci, Reno, NV (US); Dale Tilby, Leesburg, FL (US)

(21) Appl. No.: 13/226,597

(22) Filed: Sep. 7, 2011

Related U.S. Application Data
(60) Provisional application No. 61/393,340, filed on Oct. 14, 2010.

(51) Int. Cl. G08B 1/08

(52) U.S. Cl. 340/539.32

(57) ABSTRACT

A dual-signaling location system including a location device and a cellular phone case. The location device may include a sensor fob including an electronic mechanism, where said electronic mechanism activates a location button and a fob alarm; and a chain to attach said sensor fob to a key ring, where said key ring connects said sensor fob to a set of keys. The cellular phone case may include a housing to accept a mobile communication device; and a signal panel, where said signal panel houses a coordinating electronic mechanism, including a second signal button and a case alarm.

### CROSS REFERENCE TO OTHER APPLICATIONS

This application claims priority to U.S. Provisional Application Ser. No. 61/393,340 filed on Oct. 14, 2010.

### BACKGROUND OF THE INVENTION

1. Field of the Invention

The present invention relates to a location system to enable a user to locate a set of items, each equipped with an electronic mechanism which upon activation sends a signal to the other device to activate an alarm and alert the user as to the location of the misplaced item.

2. Description of Related Art

Handheld electronic devices provide some of the most convenient and easy-to-use products available to a consumer. Mobile communication devices such as cell phones have been one of the fastest growing and most popular technology devices available on the market. Cell phones are available in a wide variety of shapes, sizes and colors depending on the likes and preferences of the consumer. Although the cellphone is conveniently handheld and portable, a common problem experienced by users involves misplacing the mobile communication device, because are small and may be easily lost. It quite common for a person to be using their cell phone one minute, get distracted and put down the phone the next minute. Once they realize they need to use their phone again it is nowhere to be found. The person may take minutes or even hours looking for the phone until they finally call it from another phone or remember its location. Searching for a lost cell phone frequently causes frustration and time lost for the user. In the most unfortunate cases, the cellular phone may be permanently lost.

Accordingly, item locators are available to enable a person to attach a transmitter to a device like a remote control, a pair of glasses or even within a wallet. As disclosed in U.S. Pat. No. 5,939,981 to Renney, a multiple item locator is described to enable a user to find multiple items using a single signaling device. The signaling device transmits a signal to a specific item, which then activates an audible sound to enable the user to find the item. This device offers one way signaling to aid in locating the misplaced items.

It would be beneficial in the art to provide a two-way or dual item location system, which enables a person to transmit a signal from one handheld device to find another handheld item, and in turn that item may be used to locate the first handheld device. It would also be desirable to provide activation and deactivation buttons to enable the user to start and stop location detection on command.

### SUMMARY OF THE INVENTION

The present invention relates to a dual-signaling location system comprising a location device and a cellular phone case. The location device may include a sensor fob including a electronic mechanism, where said electronic mechanism activates a location button and a fob alarm; and a chain to attach said sensor fob to a key ring, where said key ring connects said sensor fob to a set of keys. The cellular phone case may include a housing to accept a mobile communication device; and a signal panel, where said signal panel houses a coordinating electronic mechanism, including a second signal button and a case alarm. During operation a first signal may be activated within said electronic mechanism when said location button is pressed, wherein after said first signal is activated said case alarm sounds to alert a user as to where said cellular phone case is located; and a second signal may be activated within said coordinating electronic mechanism when said second signal button is pressed, wherein after said coordinating electronic mechanism is activated said fob alarm sounds to alert said user as to where said set of keys are located.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1 depicts a perspective view of a location device in accordance with an exemplary embodiment of the present invention;

FIG. 2 depicts a backside view of a cellular phone case in accordance with an exemplary embodiment of the present invention; and

FIG. 3 depicts a front view of a cellular phone case in accordance with an exemplary embodiment of the present invention.

Like reference numerals refer to like parts throughout the description of several views of the drawings.

### DETAILED DESCRIPTION OF THE DRAWINGS

The present invention relates to a location system to enable a user to locate a set of items, each equipped with an electronic mechanism which upon activation of one of the items sends a signal to the other device to activate an alarm and alert the user as to the location of the misplaced item. The present invention is a dual-signaling location system, which enables a user to quickly and easily find missing objects, specifically a set of keys and a cellular phone. The dual-signaling location system sends a signal, which is programmed into an electronic mechanism within a key fob and a coordinating electronic mechanism within a cellular phone case. In the event that one item is misplaced, the user may simply activate the alarm within either of the devices by pushing a locating button on the other, i.e., press a key fob location button to activate the cellular phone case alarm or vice versa. The signal may trigger the alarm within the cellular phone case to sound to alert the user as to the location of the cell phone. The dual-signaling location system enables the user to send a wireless signal between two commonly misplaced items, and to allow the user to quickly and easily find their misplaced personal belongings. The dual-signaling location system provides the benefit of having two handheld devices, each equip with a detection mechanism, to enable the user to activate one device or the other to find the coordinating lost item.

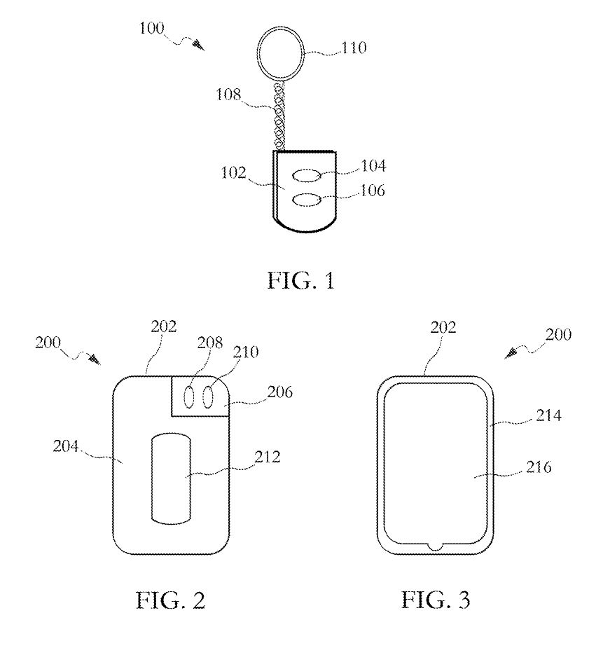

Turning now descriptively to the drawings, referring to FIG. 1, a perspective view of a location device (100) is shown in accordance with an exemplary embodiment of the present invention. The location device (100) may comprise a sensor fob (102) with a set of buttons, a location button (104) and a reset button (106). The sensor fob (102) may house an electronic mechanism to send and receive a signal. The sensor fob (102) may be attached to a chain (108), which in turn may be attached to a key ring (110). The key ring (110) may attach directly to a set of keys or to another key ring. The chain (108) may alternatively be a cord, an elastic strap or an alternative attachment means. Likewise, the key ring (110) may alternatively be a carabineer style connector for fast and easy attachment to the set of keys.

The signal fob (102) may operate by sending the signal to a coordinating electronic mechanism, and then receiving a second signal from that coordinating electronic mechanism. The coordinating electronic mechanism may be housed within a cellular phone case (as shown in FIG. 2), to enable the coordinating electronic mechanism within the cellular phone case to send the second signal back to the signal fob (102). The electronic mechanism activates the location button (104) and the reset button (106). When a user desires to locate the cellular phone case, they may simply press the location button (104), which sends the signal to the coordinating electronic mechanism within the cellular phone case. Thereafter, the coordinating electronic mechanism may activate a case alarm, which emits a beep or sound to enable the user to find the cellular phone case. Finally, once the cellular phone case is located, the user may press the reset button (106) to stop the beeping, and deactivate the case alarm.

Referring now to FIG. 2, a backside view of the cellular phone case (200) is shown in accordance with an exemplary embodiment of the present invention. The cellular phone case (200) may comprise a housing (202), including a back panel (204) and a signal panel (206). The housing (202) may hold or fit around a cellular phone or a PDA (personal digital assistant) or other type of mobile communication device. The housing (202) may comprise a set of elastic side straps (not shown), which stretch to accommodate the various sizes of mobile communication devices. The signal panel (206) may be situated against an upper portion of the back panel (204) for ease of repair and replacement within the cellular phone case (200). The signal panel (206) may house the coordinating electronic mechanism to receive the signal from the sensor fob. The signal panel (206) may have a second signal button (208) and a second reset button (210). Attached against the back panel (204) may be an attachment means (212) to connect the cellular phone case (200) to an object. For example, the attachment means (212) may be a belt loop to attach the cellular phone case (200) to the belt of the user. Alternatively, the attachment means (212) may be a clip to enable the user to clip the cellular phone case (200) against a purse, pocket, briefcase or another carrying pack.

The second signal button (208) may be pressed when the user needs to find the set of keys. When pressed, the second signal button (208) emits the second signal to the electronic mechanism within the sensor fob (102). The electronic mechanism within the sensor fob (102) activates a fob alarm, which sounds a beep or sound to alert the user as to the location of the set of keys. Once the set of keys are found, the user may press the second reset button (210) to stop the beeping. The electronic mechanism within the sensor fob (102) and the second electronic mechanism within the cellular phone case (200) are coordinating mechanisms to work together to enable the user to find one item or the other, depending on which item is misplaced.

Finally, referring to FIG. 3, a front view of the cellular phone case (200) is shown in accordance with an exemplary embodiment of the present invention. The cellular phone case (200) includes a front panel (214) with a window (216). The window (216) enables the user to press the buttons or touch screen of the mobile device. The window (216) may come in a variety of shapes and sizes depending on the various types and models of the various cellular phones. The window (216) may be covered with a clear piece of plastic or left as a cut out in the cellular phone case (200).

The location device and the cellular phone case work together comprise the dual-signaling location system to enable the user to locate one device or the other. If one of the pieces is missing the other device sends the signal to activate the alarm in the first piece, thus alerting the user as to its location, and vice versa for the other device. With the assistance of the dual-signaling location system the user will no longer misplace or lose their keys or mobile communication devices.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A dual-signaling location system comprising:
a location device comprising;
a sensor fob including an electronic mechanism, where said electronic mechanism activates a location button and a fob alarm; and
a chain to attach said sensor fob to a key ring, where said key ring connects said sensor fob to a set of keys;
a cellular phone case comprising;
a housing to accept a mobile communication device; and
a signal panel, where said signal panel houses a coordinating electronic mechanism, including a second signal button and a case alarm;
a first signal activated within said electronic mechanism when said location button is pressed, wherein after said first signal is activated said case alarm sounds to alert a user as to where said cellular phone case is located; and
a second signal activated within said coordinating electronic mechanism when said second signal button is pressed, wherein after said coordinating electronic mechanism is activated said fob alarm sounds to alert said user as to where said set of keys are located.

2. The dual-signaling location system according to claim 1, where said fob further includes a reset button, where said reset button deactivates the case alarm.

3. The dual-signaling location system according to claim 1, where said housing includes a front panel and a back panel and a set of side straps, and said signal panel is secured against a top portion of said back panel.

4. The dual-signaling location system according to claim 1, where said signal panel includes a second reset button, where said second reset button deactivates the fob alarm.

5. The dual-signaling location system according to claim 3, where the front panel includes a window and said window allows for the pressing of buttons on the front panel.
